(19) United States
(12) Patent Application Publication
(10) Pub. No.: US 2018/0054263 A1
(43) Pub. Date: Feb. 22, 2018

(54) RADIO APPARATUS AND DETECTION METHOD

(71) Applicant: FUJITSU LIMITED, Kawasaki-shi (JP)

(72) Inventors: Mitsuhiko Manpo, Sapporo (JP); KENICHI FUJII, Sapporo (JP); Naoki Shioya, Sapporo (JP); TAKESHI TSUJIMOTO, Sapporo (JP); KEIGO KURAMOTO, Sapporo (JP); Narito Matsuno, Sapporo (JP); Yasuo Nakajima, Sapporo (JP)

(73) Assignee: FUJITSU LIMITED, Kawasaki-shi (JP)

(21) Appl. No.: 15/652,850

(22) Filed: Jul. 18, 2017

(30) Foreign Application Priority Data
Aug. 22, 2016 (JP) 2016-161639

(51) Int. Cl. H04B 17/12; H04B 1/44; H04L 5/16

(52) U.S. Cl. CPC H04B 17/12; H01Q 3/267; H04L 5/16; H04B 1/44

(57) ABSTRACT

There is provided a radio apparatus including: a radio transceiver configured to transmit and receive a signal via a plurality of antennas; and a processor configured to control the radio transceiver so that a signal transmitted by a first antenna among the plurality of antennas is received by second and third antennas neighboring the first antenna and detect at least difference between amplitudes of the signals received by the respective second and third antennas or difference between phases of the signals received by the respective second and third antennas.

### CROSS-REFERENCE TO RELATED APPLICATION

This application is based upon and claims the benefit of priority of the prior Japanese Patent Application No. 2016-161639, filed on Aug. 22, 2016, the entire contents of which are incorporated herein by reference.

### FIELD

The embodiments discussed herein relate to a radio apparatus and a detection method.

### BACKGROUND

In the field of mobile networks, there is discussion on a mechanism of a new mobile network (a heterogeneous network) that improves the throughput by arranging small cells inside a macro cell covering a wide area. However, since many small cells are arranged in a macro cell in a heterogeneous network, inter-cell interference is easily caused between small cells. For this reason, beamforming has recently attracted attention, as a technique for effectively avoiding the inter-cell interference.

Beamforming is a technique for controlling the directivity of a beam by using a plurality of antennas so that the power is oriented in a certain direction. The directivity of a beam is controllable by adjusting the amplitude and the phase of a radio wave outputted from an individual antenna and orienting the direction in which the radio waves reinforce each other to a certain direction. In addition, by adjusting these amplitudes and the phases, the direction (NULL) in which the radio waves cancel each other is also controllable. Thus, by orienting the direction (NULL) to users in neighboring cells, the inter-cell interference is effectively avoided.

However, if an error is caused in the amplitude or phase adjustment, the beam or the direction NULL is shifted from its desired direction. Thus, a radio apparatus performing beamforming is adjusted in advance so that the amplitudes and the phases of the signals transmitted from the individual antennas are accurately controlled.

A signal outputted from a transmitting circuit (a TX circuit) is inputted to an antenna through a signal path connected to the antenna and is next outputted to the air via the antenna. In contrast, a signal received via an antenna is inputted to a receiving circuit (an RX circuit) through a signal path connected to the antenna. The amplitude and phase of a signal change along an aerial propagation channel, through which the signal propagates, and a signal path including an antenna. Thus, the shift amounts of the amplitude and the phase could change along the signal path as the signal path changes over time, for example. Namely, errors could be caused in the signal amplitude and phase afterward.

If such an error is caused, the beam or the direction NULL could be shifted. In addition, such an error could spread the side lobes and reduce the inter-cell interference prevention effect. However, there have been proposed methods of correcting errors in the amplitudes and phases in a radio communication system in which signals are transmitted by using a plurality of antennas.

One of the proposed methods is a method operating in a communications station for calibrating the communications station, the communications station including an antenna array of antenna elements included in a transmit apparatus chain and a receiver apparatus chain. In this method, the transmit apparatus chain associated with a certain antenna element transmits a signal, and the receiver apparatus chain not associated with the antenna element receives the signal. The communications station is calibrated by determining calibration factors of the individual antenna elements on the basis of the transfer functions associated with the respective transmit and receiver apparatus chains.

There has also been proposed a method in which wireless communication is performed by using an antenna for wireless communication and calibration processing is performed by using an antenna for calibration processing. In this method, these antennas are switched.

In addition, there has been proposed a multiple-input and multiple-output (MIMO) communication system in which transmit and receive chains are calibrated in advance by using a combination of a single receiver unit and N transmitter units and a combination of a single transmitter unit and N receiver units.

In addition, there has been proposed a radio communication device that detects time periods other than a downlink signal transmission time period as candidate time periods and starts calibration in a time period selected from the candidate time periods. In addition, there has been proposed a radio communication device based on a time division duplex (TDD) method. This communication device includes a plurality of antennas and realizes calibration by causing these antennas to transmit and receive a test signal among them. This communication device includes amplifiers and attenuators whose attenuation rate is variable. When attenuators attenuate a test signal, the communication device controls the attenuation rates so that the attenuated test signal is used as a usable power signal. See, for example, the following documents.

Japanese National Publication of International Patent Application No. 2002-530998

Japanese Laid-open Patent Publication No. 2005-130323

Japanese National Publication of International Patent Application No. 2007-531467

Japanese Laid-open Patent Publication No. 2010-041269

International Publication Pamphlet No. WO00/008777

Japanese Laid-open Patent Publication No. 2009-182441

According to the above methods, an error caused in a signal path (a transmission path) connected to a TX circuit and an error caused in a signal path (a reception path) connected to an RX circuit are not distinguished from each other. If it is possible to detect an error caused in the transmission path and reflect the error on the control on the amplitude and the phase in the TX circuit, the error could be reduced more effectively. Likewise, if it is possible to reflect an error caused in the reception path on the control on the amplitude and the phase in the RX circuit, the error could be reduced more effectively.

### SUMMARY

According to one aspect, there is provided a radio apparatus including: a radio transceiver configured to transmit and receive a signal via a plurality of antennas; and a processor configured to control the radio transceiver so that a signal transmitted by a first antenna among the plurality of antennas is received by second and third antennas neighboring the first antenna and detect at least one of difference between amplitudes of signals received by the respective second and third antennas and difference between phases of the signals received by the respective second and third antennas.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a radio apparatus according to a first embodiment;

FIG. 2 illustrates an example of a radio apparatus according to a second embodiment;

FIG. 3 illustrates an example of functions of an FPGA according to the second embodiment;

FIG. 4 illustrates an amplitude and phase correction method performed when the number of antennas is an odd number;

FIG. 5 illustrates an RX correction method according to the second embodiment (when the number of antennas is an odd number);

FIG. 6 is a flowchart illustrating RX correction processing performed by the radio apparatus according to the second embodiment (when the number of antennas is an odd number);

FIG. 7 illustrates a TX correction method according to the second embodiment (when the number of antennas is an odd number);

FIG. 8 is a flowchart illustrating a TX correction method performed by the radio apparatus according to the second embodiment (when the number of antennas is an odd number);

FIG. 9 illustrates an amplitude and phase correction method performed when the number of antennas is an even number;

FIG. 10 illustrates antenna groups and inter-group correction;

FIGS. 11 to 13 are flowcharts illustrating RX correction processing performed by the radio apparatus according to the second embodiment (when the number of antennas is an even number);

FIGS. 14 to 16 are flowcharts illustrating TX correction processing performed by the radio apparatus according to the second embodiment (when the number of antennas is an even number);

FIG. 17 illustrates comparison between radiation patterns obtained before and after amplitude and phase errors in RF circuits are corrected;

FIG. 18 illustrates correction timing control according to the second embodiment; and

FIG. 19 illustrates power control performed when the amplitude and phase correction according to the second embodiment is performed.

### DESCRIPTION OF EMBODIMENTS

Hereinafter, embodiments will be described with reference to the accompanying drawings. In the description and drawings, when elements have substantially the same function, these elements will be denoted by the same reference character, and redundant description thereof will be omitted as needed.

### 1. First Embodiment

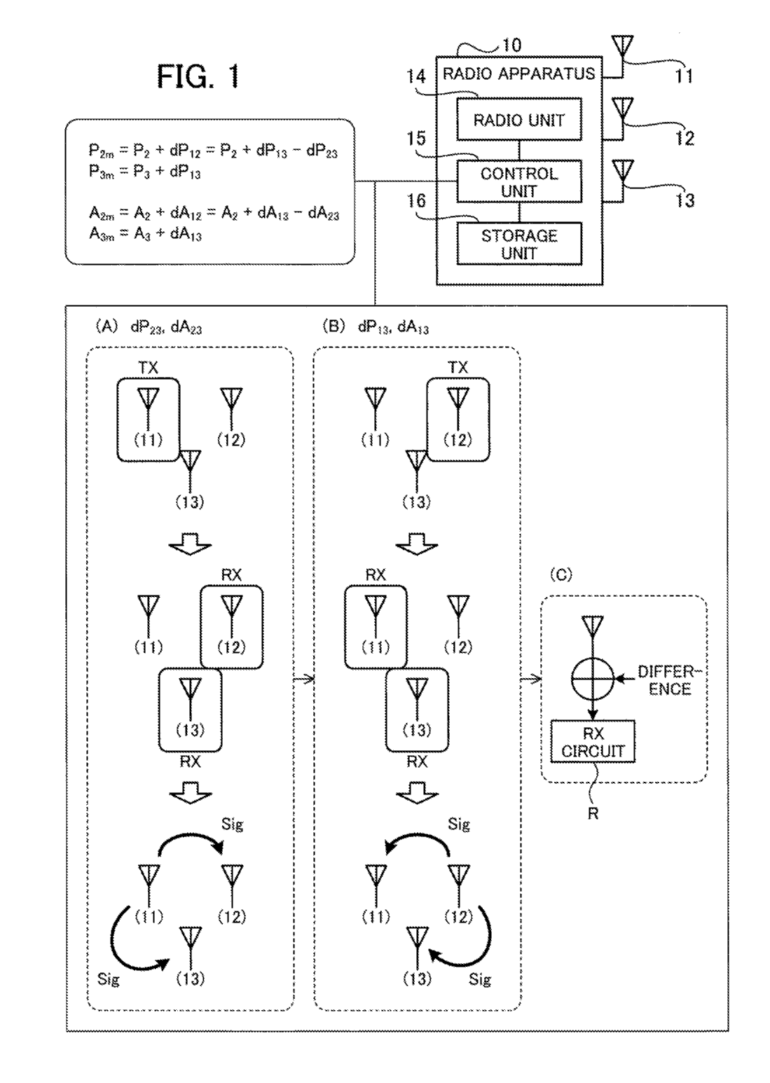

A first embodiment will be described with reference to FIG. 1. The first embodiment relates to a radio apparatus including a plurality of antennas and to a method of detecting amplitude and phase errors caused in a reception path of an individual antenna. FIG. 1 illustrates an example of a radio apparatus according to the first embodiment. This radio apparatus 10 illustrated in FIG. 1 is an example of the radio apparatus according to the first embodiment.

As illustrated in FIG. 1, the radio apparatus 10 includes antennas 11 to 13, a radio unit 14, a control unit 15, and a storage unit 16. A radio transceiver is an example of the radio unit 14. The radio transceiver may be referred to as a radio transceiver circuit, a radio transmitting/receiving circuit, radio transmitting/receiving circuitry, radio communication circuitry, radio circuitry, etc.

The radio unit 14 includes a plurality of RF (radio frequency) circuits that are connected to antennas 11 to 13, respectively. An individual RF circuit includes a transmitting circuit (TX circuit) transmitting a signal and a receiving circuit (RX circuit; a reference character R in FIG. 1) receiving a signal. An individual TX circuit controls the amplitude and phase of a signal, and an individual RX circuit detects the amplitude and phase of a signal. Hereinafter, as needed, a signal path between a TX circuit and an antenna will be referred to as a transmission path, and a signal path between an antenna and an RX circuit will be referred to as a reception path.

The control unit 15 is a processor such as a central processing unit (CPU), a digital signal processor (DSP), an application specific integrated circuit (ASIC), or a field programmable gate array (FPGA). The storage unit 16 is a volatile storage device such as a random access memory (RAM) or a non-volatile storage device such as a hard disk drive (HDD) or a flash memory.

The radio unit 14 transmits and receives a signal Sig via the antennas 11 to 13. The control unit 15 controls the radio unit 14 so that the signal Sig transmitted from a first antenna, which is one of the antennas 11 to 13, is received by second and third antennas neighboring the first antenna.

In the example in FIG. 1, the antennas 11 to 13 are arranged in this order at regular intervals. For example, the control unit 15 selects an antenna 11 as the first antenna (TX), as illustrated in (A) of FIG. 1. In addition, the control unit 15 selects the antennas 12 and 13 neighboring the antenna 11 as the second antenna (RX) and the third antenna (RX). Next, the control unit 15 causes the radio unit 14 to transmit a signal having an amplitude A₁ and a phase P₁ via the antenna 11 and to receive this signal via the antennas 12 and 13.

Since the distance between the antennas 11 and 12 is the same as the distance between the antennas 11 and 13, the shift amounts of the amplitude and phase caused between the antennas 11 and 12 are approximately equal to the shift amounts of the amplitude and phase caused between the antennas 11 and 13. In addition, since both the antennas 12 and 13 receive the same signal transmitted from the antenna 11, the shift amounts of the amplitude and phase caused in the transmission path are the same between the signals received by the antennas 12 and 13.

Thus, the difference between the amplitude and phase of a signal received by the antenna 12 and the amplitude and phase of a signal received by the antenna 13 corresponds to the difference between the shift amounts of the amplitude and phase caused in the reception path of the antenna 12 and the shift amounts of the amplitude and phase caused in the reception path of the antenna 13.

The control unit 15 detects the difference between the amplitude and phase of a signal received by the radio unit 14 via the antenna 12 and the amplitude and phase of a signal received by the radio unit 14 via the antenna 13. When an error in the amplitude or phase is negligible, the control unit 15 may detect the difference in the corresponding one of the amplitude and phase. The control unit 15 stores information about the detected difference in the storage unit 16.

Assuming that the amplitudes of signals detected by the RX circuits connected to the antennas 12 and 13 are denoted by A₂ and A₃, respectively, in the case of the example in (A) of FIG. 1, a value represented by the difference dA₂₃ (dA₂₃=A₂−A₃) is stored in the storage unit 16. Likewise, assuming that the phases corresponding to the antennas 12 and 13 are denoted by P₂ and P₃, respectively, in the case of the example in (A) of FIG. 1, a value represented by the difference dP₂₃ (dP₂₃=P₂−P₃) is stored in the storage unit 16.

In the example in (B) of FIG. 1, the antenna 12 is used as the transmitting antenna (TX), and the antennas 11 and 13 are used as the receiving antennas (RX). Assuming that the amplitude of a signal detected by the RX circuit connected to the antenna 11 is denoted by A₁, in the case of the example in (B) of FIG. 1, a value represented by the difference dA₁₃ (dA₁₃=A₁−A₃) is stored in the storage unit 16. Likewise, assuming that the phase corresponding to the antenna 11 is denoted by P₁, in the case of the example in (B) of FIG. 1, a value represented by the difference dP₁₃ (dP₁₃=P₁−P₃) is stored in the storage unit 16.

The control unit 15 refers to the storage unit 16, adds the difference dA₂₃ to the amplitude A₂ detected by the RX circuit connected to the antenna 12, and adds the difference dP₂₃ to the phase P₂ (see (C) of FIG. 1). Through this processing, the error caused by the reception paths of the antennas 12 and 13 is corrected. In addition, the control unit 15 refers to the storage unit 16, adds the difference dA₁₃ to the amplitude A₃ detected by the RX circuit connected to the antenna 13, and adds the difference dP₁₃ to the phase P₃ (see (C) of FIG. 1). Through this processing, the error caused by the reception paths of the antennas 11 and 13 is corrected.

In FIG. 1, A₂ₘ and A₃ₘ denote corrected amplitudes and P₂ₘ and P₃ₘ denote corrected phases. Through the above correction, when a signal having the same amplitude and the same phase is transmitted from a transmission point equally distanced from the antennas 11 to 13, the RX circuits connected to the antennas 11 to 13 receive the same amplitude and phase corrected.

As described above, the radio apparatus 10 is able to easily correct amplitude and phase errors caused by, for example, reception paths changed over time, without using any external antenna (an antenna arranged outside the radio apparatus 10). In addition, the radio apparatus 10 distinguishes a transmission path and a reception path from each other, detects an error caused in the reception path, and reflects the detected error on RX correction. As a result, the error caused in the reception path is effectively corrected.

The first embodiment has thus been described.

### 2. Second Embodiment

Next, a second embodiment will be described. The second embodiment relates to a radio apparatus including a plurality of antennas and to a method of correcting amplitude and phase errors caused in a reception path of an individual antenna.

[2-1. Radio Apparatus]

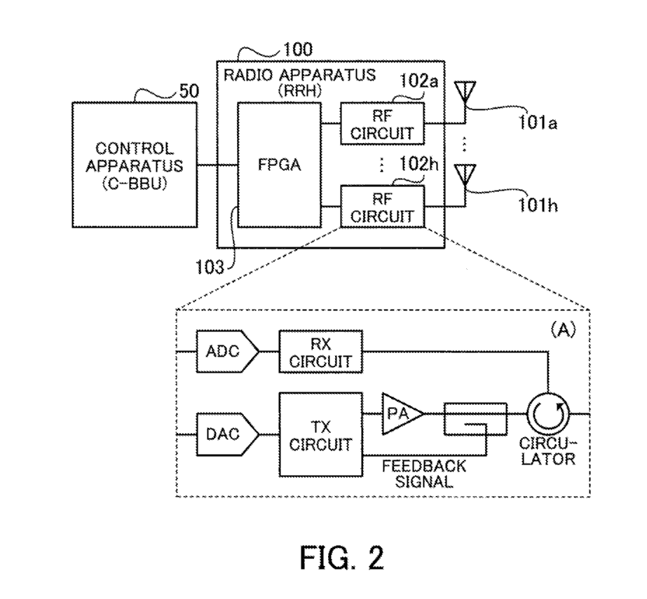

First, as an example of a radio apparatus according to a second embodiment, a radio apparatus 100 will be described with reference to FIG. 2. FIG. 2 illustrates an example of a radio apparatus according to the second embodiment.

As illustrated in FIG. 2, for example, the radio apparatus 100 is a base station apparatus such as a remote radio head (RRH) and is connected to a control apparatus 50 such as a centralized base band unit (C-BBU). The C-BBU is an example of a control apparatus that controls a plurality of RRHs in a centralized manner.

The radio apparatus 100 includes antennas 101a to 101h, RF circuits 102a to 102h, and an FPGA 103. While the radio apparatus 100 in the example in FIG. 2 includes eight antennas for convenience of the description, the number of antennas of the radio apparatus 100 may be any number equal to 3 or more. The antennas 101a to 101h are connected to the respective RF circuits 102a to 102h. Each of the RF circuits 102a to 102h includes the same elements.

(A) of FIG. 2 illustrates main elements of the RF circuit 102h. For example, the RF circuit 102h includes, as its main elements, an RX circuit that detects the amplitude and phase of a signal received by the antenna 101h, a TX circuit that controls the phase of a signal transmitted by the antenna 101h, and a power amplifier (PA). In addition, the RF circuit 102h includes a circulator that switches a reception path connecting the antenna 101h and the RX circuit and a transmission path connecting the antenna 101h and the TX circuit.

In addition, the RF circuit 102h includes a digital-to-analog converter (DAC) that converts a digital signal outputted from the FPGA 103 to the TX circuit into an analog signal. In addition, the RF circuit 102h includes an analog-to-digital convertor (ADC) that converts an analog signal outputted from the RX circuit to the FPGA 103 into a digital signal. In addition, the RF circuit 102h includes a branch path or the like for acquiring a feedback signal used for negative feedback control.

The radio apparatus 100 includes beamforming functions, for example. In this case, the FPGA 103 controls each of the RF circuits 102a to 102h, adjusts the amplitudes and phases of signals simultaneously transmitted and received by the antennas 101a to 101h, and controls the directivity of an individual beam formed by the antennas 101a to 101h.

The transmission paths and the reception paths connected to the antennas 101a to 101h may have different lengths, depending on the design or the like. Thus, adjustment values of the RF circuits 102a to 102h are set in advance so that the amplitudes and phases of the signals outputted by the antennas 101a to 101h are appropriately adjusted by the RF circuits 102a to 102h and a beam is accurately oriented in a desired direction. However, for example, as these transmission and reception paths deteriorate over time, amplitude and phase errors could be caused. Thus, the FPGA 103 according to the second embodiment includes a function of correcting these errors.

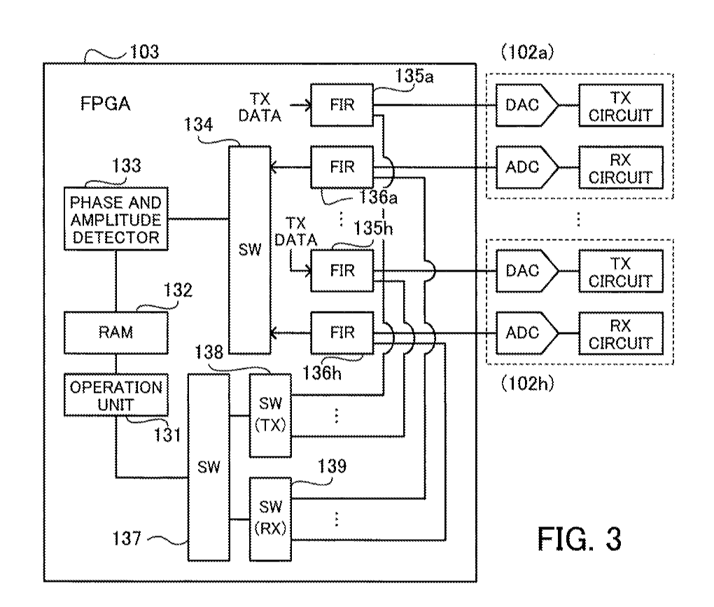

As illustrated in FIG. 3, the FPGA 103 includes, as main elements of the above error correction function, an operation unit 131, a RAM 132, a phase and amplitude detector 133, switches (SWs) 134, 137, 138, and 139, and finite impulse responses (FIR) 135a to 135h and 136a to 136h. FIG. 3 illustrates an example of functions of the FPGA according to the second embodiment.

The operation unit 131 is a circuit element that performs operation processing of the FPGA 103. The phase and amplitude detector 133 is a circuit element that detects the phases and amplitudes of the signals received by the antennas 101a to 101h. The switch 134 switches paths connected to the FIRs 136a to 136h (corresponding to the RX circuits of the RF circuits 102a to 102h).

The switch 137 switches a path connected to one of the FIRs 135a to 135h (corresponding to the TX circuits of the RF circuits 102a to 102h) and a path connected to one of the FIRs 136a to 136h (corresponding to the RX circuits of the RF circuits 102a to 102h). The switch 138 switches paths connected to the FIRs 135a to 135h (corresponding to the TX circuits of the RF circuits 102a to 102h). The switch 139 switches paths connected to the FIRs 136a to 136h (corresponding to the RX circuits of the RF circuits 102a to 102h).

The FIRs 135a to 135h and 136a to 136h are circuit elements that change characteristics of the amplitudes and phases of signals passing therethrough. Each of the FIRs 135a to 135h changes the amplitude and phase of a passing signal on the basis of a control signal inputted by the operation unit 131 via the switches 137 and 138 (on the basis of a signal specifying shift amounts of the amplitude and phase). Each of the FIRs 136a to 136h changes the amplitude and phase of a passing signal on the basis of a control signal inputted by the operation unit 131 via the switches 137 and 139 (on the basis of a signal specifying shift amounts of the amplitude and phase).

When performing the above correction, the operation unit 131 selects a combination of transmitting and receiving antennas. For example, when correcting an error caused in a reception path, the operation unit 131 selects a single transmitting antenna and two receiving antennas neighboring the transmitting antenna. Next, the operation unit 131 transmits a signal by controlling the RF circuit connected to the transmitting antenna selected from the RF circuits 102a to 102h.

In addition, the operation unit 131 switches the switch 134 so that the paths of the two selected receiving antennas are connected to the phase and amplitude detector 133. The phase and amplitude detector 133 detects the amplitudes and phases of the signals inputted via the switch 134 and stores information about the detected amplitudes and phases in the RAM 132.

The operation unit 131 detects the above errors from the amplitude and phase information stored in the RAM 132 and switches the switches 137 and 139 so that an FIR connected to a reception path on which error correction is performed is connected to the operation unit 131. Next, the operation unit 131 outputs a control signal specifying the shift amounts of the amplitude and phase that have been set to cancel out the amplitude and phase errors. When receiving the control signal outputted from the operation unit 131, the FIR connected to the operation unit 131 shifts the amplitude and phase of the signal by the respective shift amounts specified by the control signal.

In contrast, when correcting an error caused in a transmission path, the operation unit 131 selects a single receiving antenna and two transmitting antennas neighboring the receiving antenna. Next, the operation unit 131 transmits the same signal by controlling the RF circuits connected to the transmitting antennas selected from the RF circuits 102a to 102h.

In addition, the operation unit 131 switches the switch 134 so that the path of the selected receiving antenna is connected to the phase and amplitude detector 133. The phase and amplitude detector 133 detects the amplitudes and phases of the signals inputted via the switch 134 and stores information about the detected amplitudes and phases in the RAM 132.

The operation unit 131 detects the above errors from the amplitude and phase information stored in the RAM 132 and switches the switches 137 and 138 so that an FIR connected to a transmission path on which error correction is performed is connected to the operation unit 131. Next, the operation unit 131 outputs a control signal specifying the shift amounts of the amplitude and phase that have been set to cancel out the amplitude and phase errors. When receiving the control signal outputted from the operation unit 131, the FIR connected to the operation unit 131 shifts the amplitude and phase of the signal by the respective shift amounts specified by the control signal.

Next, a method (RX correction) of correcting an error caused in a reception path and a method (TX correction) of correcting an error caused in a transmission path will be described in detail.

[2-2. Correction Method #1: When the Number of Antennas is an Odd Number]

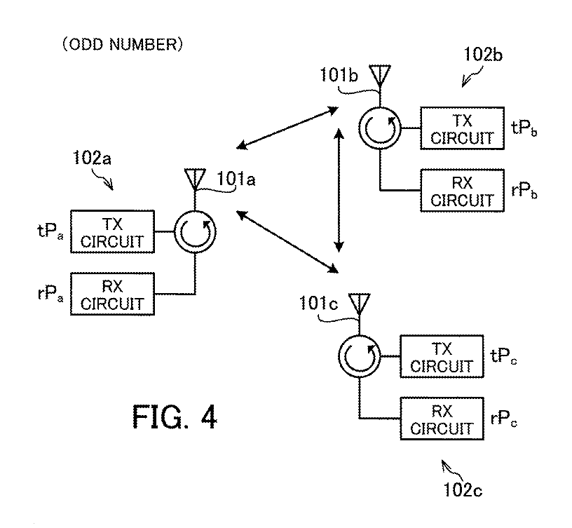

First, RX correction and TX correction when the number of antennas is an odd number will be described with reference to FIG. 4. FIG. 4 illustrates an amplitude and phase correction method performed when the number of antennas is an odd number.

In the example in FIG. 4, for convenience of the description, the radio apparatus 100 includes three antennas 101a to 101c. In addition, the distance between the antennas 101a and 101b, the distance between the antennas 101b and 101c, and the distance between the antennas 101c and 101a are the same.

In addition, the phase shift amounts caused in the transmission and reception paths of the antenna 101a will be denoted by tPₐ and rPₐ, respectively. Likewise, the phase shift amounts caused in the transmission and reception paths of the antenna 101b will be denoted by tP_{b} and rP_{b}, respectively. Likewise, the phase shift amounts caused in the transmission and reception paths of the antenna 101c will be denoted by tP_{c} and rP_{c}, respectively.

In addition, the phase shift amount caused between neighboring antennas (between the antennas 101a and 101b, between the antennas 101b and 101c, and between the antennas 101c and 101a) will be denoted by Pₛₚ. In addition, the difference between tPᵢ and tPⱼ (i, j=a, b, c; i≠j) will be denoted by ΔtPᵢⱼ (ΔtPᵢⱼ=tPᵢ−tPⱼ). Likewise, the difference between rPᵢ and rPⱼ (i, j=a, b, c; i≠j) will be denoted by ΔrPᵢⱼ (ΔrPᵢ=rPᵢ−rPⱼ).

(RX Correction)

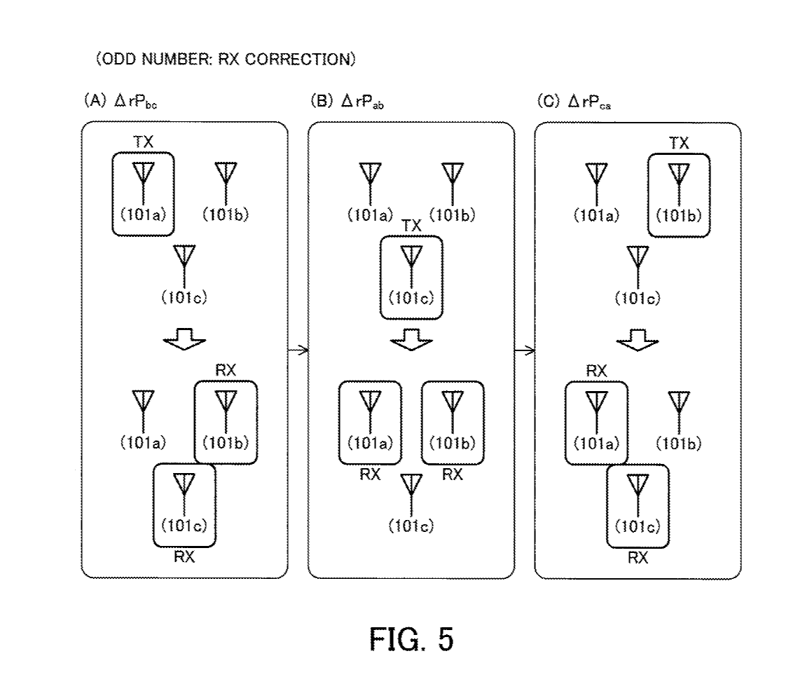

First, RX correction will be described with reference to FIG. 5. FIG. 5 illustrates an RX correction method according to the second embodiment (when the number of antennas is an odd number).

In the example in FIG. 5, first, as illustrated in (A) of FIG. 5, the antenna 101a is selected as the transmitting antenna (TX) from the antennas 101a to 101c. In addition, the antennas 101b and 101c neighboring the antenna 101a are selected as the receiving antennas (RX). In this case, a signal transmitted by the antenna 101a is received by the antennas 101b and 101c.

Between when the signal is outputted by the TX circuit connected to the antenna 101a and when the signal is inputted to the RX circuit connected to the antenna 101b, the phase of the signal changes by tPₐ in the transmission path, changes by Pₛₚ in the air, and changes by rP_{b} in the reception path. Namely, the phase shift amount of the signal received by the antenna 101b is represented by (tPₐ+Pₛₚ+rP_{b}). Likewise, the phase shift amount of the signal received by the antenna 101c is represented by (tPₐ+Pₛₚ+rP_{c}).

Thus, the difference between the phases of the signals received by the antennas 101b and 101c is represented by (rP_{b}−rP_{c}). Namely, ΔrP_{bc} is the difference between the phase shift amounts caused in the reception paths of the antennas 101b and 101c. If there is no change over time in the reception paths of the antennas 101b and 101c, ΔrP_{bc} is 0 (a negligible level).

Next, when an error between the phases in the reception paths of the antennas 101a and 101b is detected, as illustrated in (B) of FIG. 5, the antenna 101c is selected as the transmitting antenna (TX) from the antennas 101a to 101c. In addition, the antennas 101b and 101a neighboring the antenna 101c are selected as the receiving antennas (RX). In this case, a signal transmitted by the antenna 101c is received by the antennas 101b and 101a.

Between when the signal is outputted by the TX circuit connected to the antenna 101c and when the signal is inputted to the RX circuit connected to the antenna 101b, the phase of the signal changes by tP_{c} in the transmission path, changes by Pₛₚ in the air, and changes by rP_{b} in the reception path. Namely, the phase shift amount of the signal received by the antenna 101b is represented by (tP_{c}+Pₛₚ+rP_{b}). Likewise, the phase shift amount of the signal received by the antenna 101a is represented by (tP_{c}+Pₛₚ+rPₐ).

Thus, the difference between the phases of the signals received by the antennas 101b and 101a is represented by (rP_{b}−rPₐ). Namely, ΔrP_{ba} (−ΔrP_{ab}) is the difference between the phase shift amounts caused in the reception paths of the antennas 101b and 101a. If there is no change over time in the reception paths of the antennas 101b and 101a, ΔrP_{ba} is 0 (a negligible level). Likewise, by selecting a transmitting antenna and a pair of receiving antennas as illustrated in (C) of FIG. 5, the difference ΔrP_{ca} (−ΔrP_{ac}) between the phase shift amounts caused in the reception paths of the antennas 101c and 101a is obtained.

The antenna selection order is not limited to the above example. In addition, the operation unit 131 selects the antennas and calculates the difference ΔrPᵢⱼ (i, j=a, b, c; i≠j). In addition, when acquiring the difference ΔrPᵢⱼ, the operation unit 131 controls the phase shift amount applied to an FIR connected to a receiving antenna so that the signal phase is shifted by the difference ΔrPᵢⱼ in the path corresponding to the receiving antenna.

When the number of antennas is an odd number, a pair of receiving antennas is sequentially selected in accordance with the above method, and the difference between phase shift amounts of an individual pair is detected. In this way, a phase error caused in the reception path of an individual antenna is corrected on the basis of the detected difference. The amplitude error is corrected in the same way by replacing the “phase shift amount” in the above description with “amplitude shift amount.”

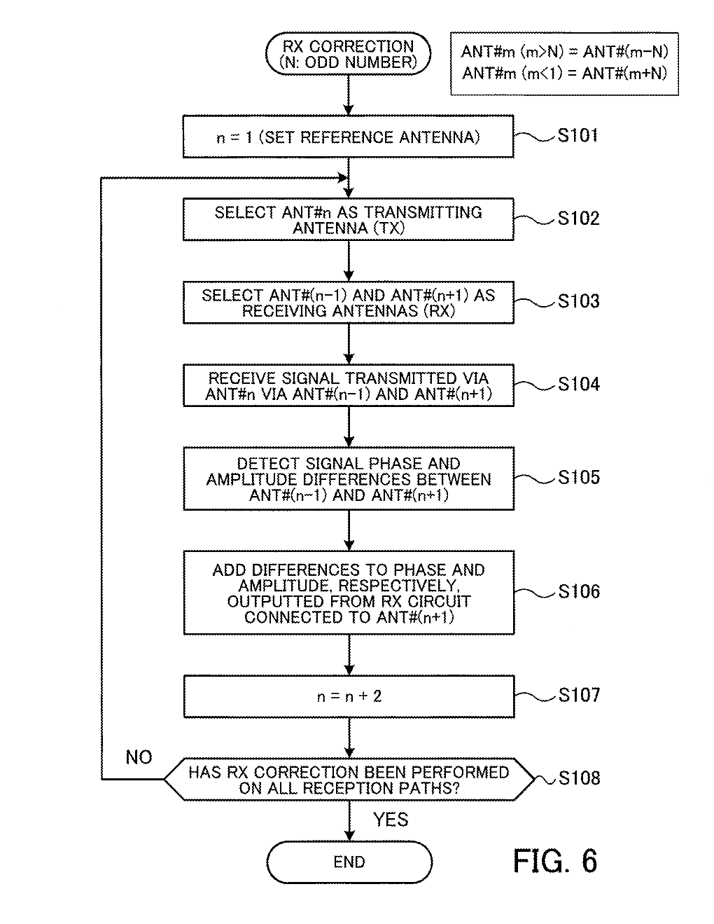

Next, RX correction processing performed by the radio apparatus 100 will be described in more detail with reference to FIG. 6. FIG. 6 is a flowchart illustrating RX correction processing performed by the radio apparatus according to the second embodiment (when the number of antennas is an odd number).

In the following example, for convenience of the description, the radio apparatus 100 includes N antennas (N is an odd number) and the n-th antenna will be referred to as ANT#n. In addition, ANT#m(m>N) and ANT#(m−N) represent the same antenna. In addition, ANT#m(m<1) and ANT#(m+N) represent the same antenna. In addition, ANT#1, ANT#2, . . . , ANT#N are arranged at regular intervals in the order of their indexes #1, #2, . . . , N.

(S101) The operation unit 131 selects ANT#1 as a reference antenna and sets the index n to 1. Namely, error correction is performed so that, when a signal is transmitted from a transmission point equally distanced from ANT#1, #2, . . . , #N, the amplitudes and the phases of the signals received by ANT#2, . . . , #N will be equal to the amplitude and the phase of the signal received by ANT#1.

(S102) The operation unit 131 selects ANT#n as the transmitting antenna (TX).

(S103) The operation unit 131 selects ANT#(n−1) and ANT#(n+1) as the receiving antennas (RX). Namely, the operation unit 131 selects the two antennas neighboring ANT#n as the receiving antennas.

(S104) The operation unit 131 causes the RF circuit connected to the transmitting antenna to transmit a signal via ANT#n and causes the RF circuits connected to the receiving antennas to receive the signal transmitted via ANT#n via ANT#(n−1) and ANT#(n+1).

(S105) The phase and amplitude detector 133 detects the amplitudes and phases of the signals received by ANT#(n−1) and ANT#(n+1) and stores information about the detected amplitudes and phases in the RAM 132. The operation unit 131 refers to the information stored in the RAM 132 and detects the difference ΔrP₍ₙ₋₁₎₍ₙ₊₁₎ between the phases of the signals received by ANT#(n−1) and ANT#(n+1). The operation unit 131 detects the difference ΔrA₍ₙ₋₁₎₍ₙ₊₁₎ between the amplitudes in the same way.

The phase shift amount caused in the transmission path of ANT#k (k=1, 2, . . . , N) will be denoted by tPₖ, and the phase shift amount caused in the reception path of ANT#k will be denoted by rPₖ. In addition, the amplitude shift amount caused in the transmission path of ANT#k will be denoted by tAₖ, and the amplitude shift amount caused in the reception path of ANT#k will be denoted by rAₖ. When ANT#(k−1) and ANT#(k+1) are selected as the receiving antennas, the phase difference ΔrP₍ₖ₋₁₎₍ₖ₊₁₎ is represented by (rP₍ₖ₋₁₎−rP₍ₖ₊₁₎), and the amplitude difference ΔrA₍ₖ₋₁₎₍ₖ₊₁₎ is represented by (rA₍ₖ₋₁₎−rA₍ₖ₊₁₎).

(S106) The operation unit 131 sets a phase shift amount in an FIR connected to an RX circuit connected to ANT#(n+1) so that the difference ΔrP₍ₙ₋₁₎₍ₙ₊₁₎ is added to the signal phase outputted from the RX circuit. In addition, the operation unit 131 sets an amplitude shift amount in the FIR connected to the RX circuit connected to ANT#(n+1) so that the difference ΔrA₍ₙ₋₁₎₍ₙ₊₁₎ is added to the signal amplitude outputted from the RX circuit.

(S107) The operation unit 131 increments the index n by 2.

(S108) The operation unit 131 determines whether RX correction has been performed on all the reception paths (correction on the signal amplitudes and phases outputted from all the RX circuits). For example, when all pairs of selectable receiving antennas have been selected, the operation unit 131 determines that the RX correction has been performed. When the RX correction has been performed, the operation unit 131 ends the processing in FIG. 6. Otherwise, the processing proceeds to S102.

The RX correction performed when the number of antennas is an odd number has thus been described.

(TX Correction)

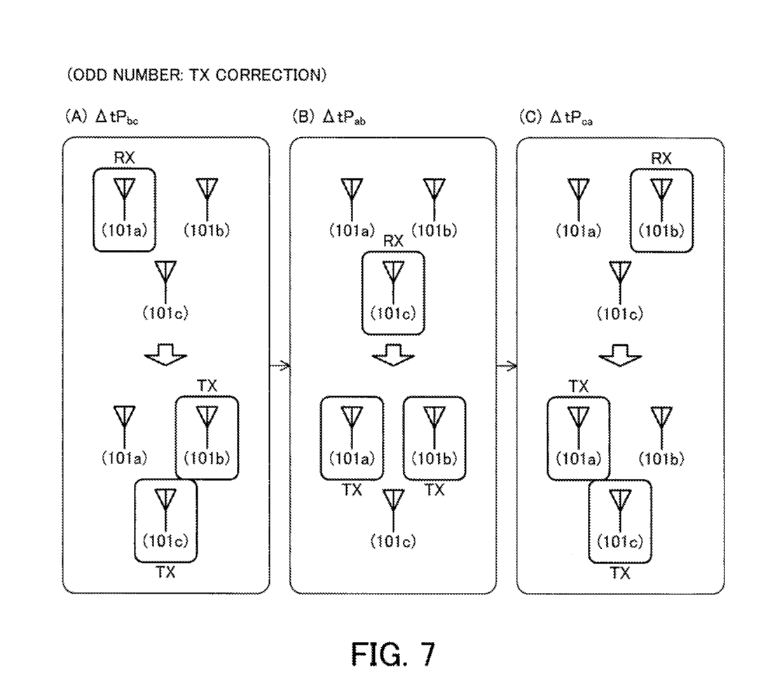

Next, TX correction will be described with reference to FIG. 7. FIG. 7 illustrates a TX correction method according to the second embodiment (when the number of antennas is an odd number).

In the example in FIG. 7, first, as illustrated in (A) of FIG. 7, the antenna 101a is selected as the receiving antenna (RX) from the antennas 101a to 101c. In addition, the antennas 101b and 101c neighboring the antenna 101a are selected as the transmitting antennas (TX). In this case, signals transmitted by the antennas 101b and 101c are received by the antenna 101a.

Between when the signal is outputted by the TX circuit connected to the antenna 101b and when the signal is inputted to the RX circuit connected to the antenna 101a, the phase of the signal changes by tP_{b} in the transmission path, changes by Pₛₚ in the air, and changes by rPₐ in the reception path. Namely, the phase shift amount of the signal received by the antenna 101a is represented by (tP_{b}+Pₛₚ+rPₐ). Likewise, the phase shift amount of the signal transmitted by the antenna 101c is represented by (tP_{c}+Pₛₚ+rPₐ).

Thus, the difference between the phases of the signals transmitted by the antennas 101b and 101c is represented by (tP_{b}−tP_{c}). Namely, ΔtP_{bc} is the difference between the phase shift amounts caused in the transmission paths of the antennas 101b and 101c. If there is no change over time in the transmission paths of the antennas 101b and 101c, ΔtP_{bc} is 0 (a negligible level).

Next, when an error between the phases in the transmission paths of the antennas 101a and 101b is detected, as illustrated in (B) of FIG. 7, the antenna 101c is selected as the receiving antenna (RX) from the antennas 101a to 101c. In addition, the antennas 101b and 101a neighboring the antenna 101c are selected as the transmitting antennas (TX). In this case, signals transmitted by the antennas 101b and 101a are received by the antenna 101c.

Between when the signal is outputted by the TX circuit connected to the antenna 101b and when the signal is inputted to the RX circuit connected to the antenna 101c, the phase of the signal changes by tP_{b} in the transmission path, changes by Pₛₚ in the air, and changes by rP_{c} in the reception path. Namely, the phase shift amount of the signal transmitted by the antenna 101b is represented by (tP_{b}+Pₛₚ+rP_{c}). Likewise, the phase shift amount of the signal transmitted by the antenna 101a is represented by (tPₐ+Pₛₚ+rP_{c}).

Thus, the difference between the phases of the signals transmitted by the antennas 101b and 101a is represented by (tP_{b}−tPₐ). Namely, ΔtP_{ba} (−ΔtP_{ab}) is the difference between the phase shift amounts caused in the transmission paths of the antennas 101b and 101a. If there is no change over time in the transmission paths of the antennas 101b and 101a, ΔtP_{ba} is 0 (a negligible level). Likewise, by selecting a pair of transmitting antennas and a receiving antenna as illustrated in (C) of FIG. 7, the difference ΔtP_{ca} (−ΔtP_{ac}) between the phase shift amounts caused in the transmission paths of the antennas 101c and 101a is obtained.

The antenna selection order is not limited to the above example. In addition, the operation unit 131 selects the antennas and calculates the difference ΔtPᵢⱼ (i, j=a, b, c; i≠j). In addition, when acquiring the difference ΔtPᵢⱼ, the operation unit 131 controls the phase shift amount applied to an FIR connected to a transmitting antenna so that the signal phase is shifted by the difference ΔtPᵢⱼ in the path corresponding to the transmitting antenna.

When the number of antennas is an odd number, a pair of transmitting antennas is sequentially selected in accordance with the above method, and the difference between phase shift amounts of an individual pair is detected. In this way, a phase error caused in the transmission path of an individual antenna is corrected on the basis of the detected difference. The amplitude error is corrected in the same way by replacing the “phase shift amount” in the above description with “amplitude shift amount.”

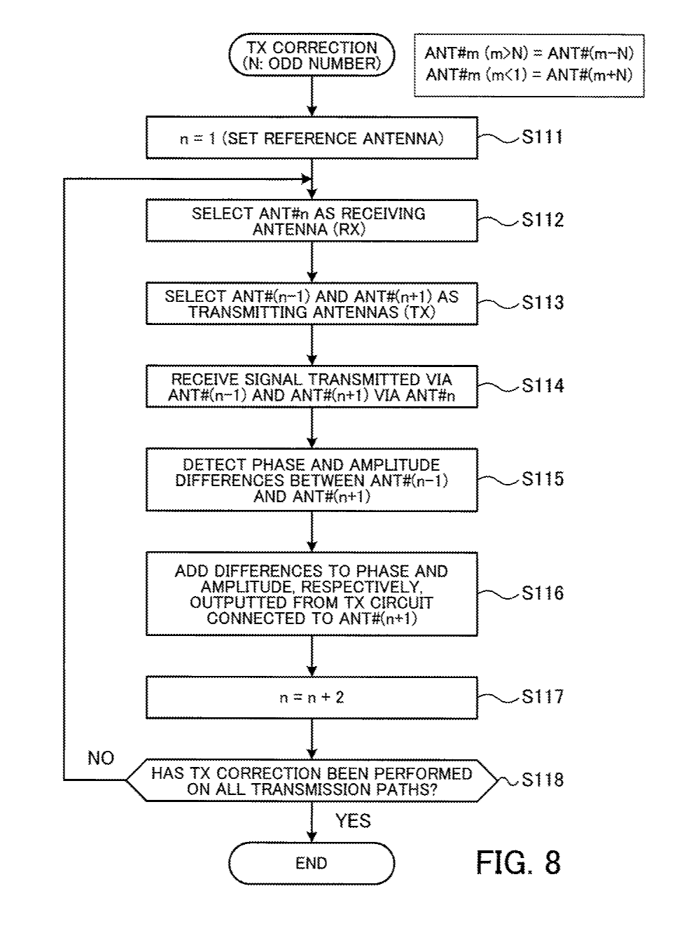

Next, TX correction processing performed by the radio apparatus 100 will be described in more detail with reference to FIG. 8. FIG. 8 is a flowchart illustrating TX correction processing performed by the radio apparatus according to the second embodiment (when the number of antennas is an odd number).

In the following example, for convenience of the description, the radio apparatus 100 includes N antennas (N is an odd number) and the n-th antenna will be referred to as ANT#n. In addition, ANT#m(m>N) and ANT#(m−N) represent the same antenna. In addition, ANT#m(m<1) and ANT#(m+N) represent the same antenna. In addition, ANT#1, ANT#2, . . . , ANT#N are arranged at regular intervals in the order of their indexes #1, #2, . . . , N.

(S111) The operation unit 131 selects ANT#1 as a reference antenna and sets the index n to 1. Namely, error correction is performed so that, when the same signals are transmitted to a reception point equally distanced from ANT#1, #2, . . . , #N, the amplitudes and the phases of the signals transmitted by ANT#2, . . . , #N will be equal to the amplitude and the phase of the signal transmitted by ANT#1 at the reception point.

(S112) The operation unit 131 selects ANT#n as the receiving antenna (RX).

(S113) The operation unit 131 selects ANT#(n−1) and ANT#(n+1) as the transmitting antennas (TX). Namely, the operation unit 131 selects the two antennas neighboring ANT#n as the transmitting antennas.

(S114) The operation unit 131 causes the RF circuits connected to the respective transmitting antennas to transmit the same signal via ANT#(n−1) and ANT#(n+1) and causes the RF circuit connected to the receiving antenna to receive the signals transmitted via ANT#(n−1) and ANT#(n+1) via ANT#n.

(S115) The phase and amplitude detector 133 detects the amplitudes and phases of the signals transmitted by ANT#(n−1) and ANT#(n+1) and stores information about the detected amplitudes and phases in the RAM 132. The operation unit 131 refers to the information stored in the RAM 132 and detects the difference ΔtP₍ₙ₋₁₎₍ₙ₊₁₎ between the phases of the signals transmitted by ANT#(n−1) and ANT#(n+1). The operation unit 131 detects the difference ΔtA₍ₙ₋₁₎₍ₙ₊₁₎ between the amplitudes in the same way.

The phase shift amount caused in the transmission path of ANT#k (k=1, 2, . . . , N) will be denoted by tPₖ, and the phase shift amount caused in the reception path of ANT#k will be denoted by rPₖ. In addition, the amplitude shift amount caused in the transmission path of ANT#k will be denoted by tAₖ, and the amplitude shift amount caused in the reception path of ANT#k will be denoted by rAₖ. When ANT#(k−1) and ANT#(k+1) are selected as the transmitting antennas, the phase difference ΔtP₍ₖ₋₁₎₍ₖ₊₁₎ is represented by (tP₍ₖ₋₁₎−tP₍ₖ₊₁₎), and the amplitude difference ΔtA₍ₖ₋₁₎₍ₖ₊₁₎ is represented by (tA₍ₖ₋₁₎−tA₍ₖ₊₁₎).

(S116) The operation unit 131 sets a phase shift amount in an FIR connected to a TX circuit connected to ANT#(n+1) so that the difference ΔtP₍ₙ₋₁₎₍ₙ₊₁₎ is added to the signal phase outputted from the TX circuit. In addition, the operation unit 131 sets an amplitude shift amount in the FIR connected to the TX circuit connected to ANT#(n+1) so that the difference ΔtA₍ₙ₋₁₎₍ₙ₊₁₎ is added to the signal amplitude outputted from the TX circuit.

(S117) The operation unit 131 increments the index n by 2.

(S118) The operation unit 131 determines whether TX correction has been performed on all the transmission paths (correction on the signal amplitudes and phases outputted from all the TX circuits). For example, when all pairs of selectable transmitting antennas have been selected, the operation unit 131 determines that the TX correction has been performed. When the TX correction has been performed, the operation unit 131 ends the processing in FIG. 8. Otherwise, the processing proceeds to S112.

The TX correction performed when the number of antennas is an odd number has thus been described.

[2-3. Correction Method #2: When the Number of Antennas is an Even Number]

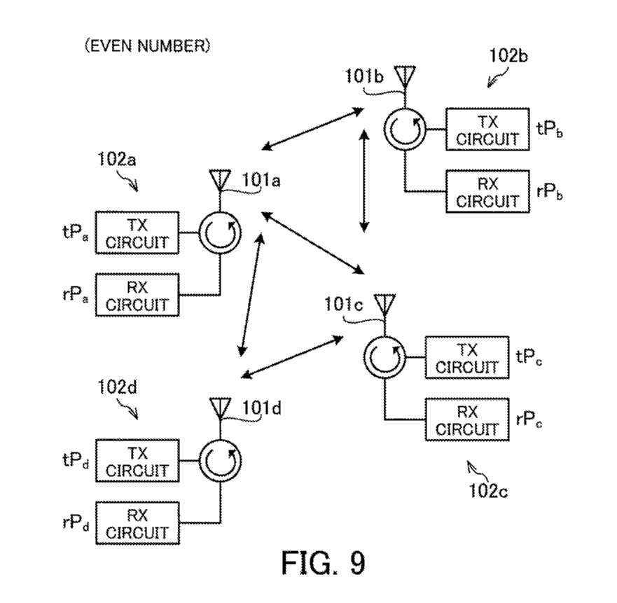

Next, RX and TX correction performed when the number of antennas is an even number will be described with reference to FIG. 9. FIG. 9 illustrates an amplitude and phase correction method performed when the number of antennas is an even number.

In the example in FIG. 9, for convenience of the description, the radio apparatus 100 includes four antennas 101a to 101d. In addition, the distance between the antennas 101a and 101b, the distance between the antennas 101b and 101c, the distance between the antennas 101c and 101d, and the distance between the antennas 101d and 101a are the same.

In addition, the phase shift amounts caused in the transmission and reception paths of the antenna 101a will be denoted by tPₐ and rPₐ, respectively. Likewise, the phase shift amounts caused in the transmission and reception paths of the antenna 101b will be denoted by tP_{b} and rP_{b}, respectively. Likewise, the phase shift amounts caused in the transmission and reception paths of the antenna 101c will be denoted by tP_{c} and rP_{c}, respectively. Likewise, the phase shift amounts caused in the transmission and reception paths of the antenna 101d will be denoted by tP_{d} and rP_{d}, respectively.

In addition, the phase shift amount caused between neighboring antennas (between the antennas 101a and 101b, between the antennas 101b and 101c, between the antennas 101c and 101d, and between the antennas 101d and 101a) will be denoted by Pₛₚ. In addition, the difference between tPᵢ and tPⱼ (i, j=a, b, c, d; i≠j) will be denoted by ΔtPᵢⱼ (ΔtPᵢⱼ=tPᵢ−tPⱼ). Likewise, the difference between rPᵢ and rPⱼ (i, j=a, b, c, d; i≠j) will be denoted by ΔrPᵢⱼ (ΔrPᵢⱼ=rPᵢ−rPⱼ).

When the number of antennas is an odd number, the operation unit 131 selects a single transmitting antenna and two receiving antennas neighboring the transmitting antenna while sequentially changing the transmitting antenna. In this way, the operation unit 131 selects an individual pair of receiving antennas used to correct errors in the respective reception paths. However, when the number of antennas is an even number, the above selection method produces two antenna groups on which error correction has separately been performed. Namely, error correction between the antenna groups has not been performed.

For example, in the case of RX correction on the phase in the example of FIG. 9, when the antenna 101b is selected as the transmitting antenna, the antennas 101a and 101c are selected as the receiving antennas. With this selection, the error ΔrP_{ac} between the antennas 101a and 101c is corrected. When the antenna 101c is selected as the transmitting antenna, the antennas 101b and 101d are selected as the receiving antennas. With this selection, the error ΔrP_{bd} between the antennas 101b and 101d is corrected.

Likewise, when the antenna 101d is selected as the transmitting antenna, the antennas 101c and 101a are selected as the receiving antennas. When the antenna 101a is selected as the transmitting antenna, the antennas 101d and 101b are selected as the receiving antennas. With these selections, the errors ΔrP_{ac}(−ΔrP_{ca}) and ΔrP_{bd}(−ΔrP_{db}) are corrected.

Namely, while the error ΔrP_{ac} between the antennas 101a and 101c and the error ΔrP_{bd} between the antennas 101b and 101d are corrected, the error ΔrP_{ab} between the antennas 101a and 101b is not corrected. In this case, the antennas 101a and 101c form one antenna group, and the antennas 101a and 101b form the other antenna group. Under such circumstances, when the number of antennas is an even number, the radio apparatus 100 includes a function of correcting the error between two antenna groups (inter-group correction function).

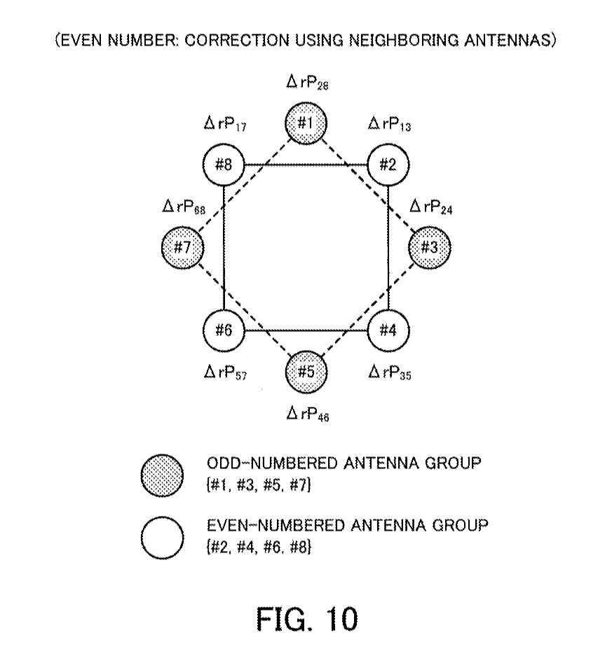

Next, antenna groups and inter-group correction will be described in more detail with reference to FIG. 10. FIG. 10 illustrates antenna groups and inter-group correction. For convenience of the description, in FIG. 10, eight antennas are used, which are distinguished by their respective indexes #1, #2, . . . , #8. In addition, an antenna having an index#k (k=1, 2, . . . , 8) will be denoted by ANT#k. As illustrated in FIG. 10, ANT#1, ANT#2, . . . , ANT#8 are arranged at regular intervals in the order of their indexes.

In the case of RX correction, a single transmitting antenna and two receiving antennas neighboring the transmitting antenna are selected. For example, when ANT#1 is selected as the transmitting antenna, ANT#8 and ANT#2 are selected as the receiving antennas. Thus, the error ΔrP₂₈ between ANT#8 and ANT#2 is corrected.

Likewise, when ANT#k (k=2, . . . , 8) is selected as the transmitting antenna, ANT#(k−1) and ANT#(k+1) are selected as the receiving antennas. ANT#m(m<1) and ANT#(m+8) represent the same antenna, and ANT#m(m>8) and ANT#(m−8) represent the same antenna. Thus, the error ΔrP₍ₖ₋₁₎₍ₖ₊₁₎ between ANT#(k−1) and ANT#(k+1) is corrected.

One antenna group is a group of antennas having odd-numbered indexes (an odd-numbered antenna group; ANT#1, ANT#3, ANT#5, and ANT#7). By applying the above correction method, errors caused in the reception paths of the antennas in the odd-numbered antenna group are corrected. Namely, the amplitudes and the phases are accurately corrected among a group of antennas (the odd-numbered antenna group) connected by a chain line in FIG. 10.

The other antenna group is a group of antennas having even-numbered indexes (an even-numbered antenna group; ANT#2, ANT#4, ANT#6, and ANT#8). By applying the above correction method, errors caused in the reception paths of the antennas in the even-numbered antenna group are corrected. Namely, the amplitudes and the phases are accurately corrected among a group of antennas (the even-numbered antenna group) connected by a solid line in FIG. 10.

To correct the amplitude and phase errors between the odd-numbered antenna group and the even-numbered antenna group, the operation unit 131 selects a single transmitting antenna and three receiving antennas. For example, when the transmitting antenna belongs to the odd-numbered antenna group, the operation unit 131 selects two antennas equally distanced from the transmitting antenna as two of the receiving antennas from the even-numbered antenna group. In addition, the operation unit 131 selects a single antenna equally distanced from the two receiving antennas as the other receiving antenna from the odd-numbered antenna group.

Next, the operation unit 131 causes the RF circuit connected to the selected transmitting antenna to transmit a signal via the selected transmitting antenna and causes RF circuits connected to the selected three receiving antennas to receive the signal via the selected three receiving antennas. For example, the operation unit 131 selects ANT#1 as the transmitting antenna and selects ANT#4, ANT#5, and ANT#6 as the receiving antennas. When the phase of a signal received by the RX circuit connected to ANT#k (k=4, 5, 6) is denoted by gPrₖ, the phase error ΔgPr (inter-group error) between the odd-numbered antenna group and the even-numbered antenna group is represented by {(gPr₅−gPr₄)−(gpr₅−gPr₆)}.

Namely, by obtaining the phase error between a receiving antenna selected from the antenna group to which the transmitting antenna belongs and the receiving antennas selected from the antenna group to which the transmitting antenna does not belong, the inter-group error is obtained. In accordance with the above method, the operation unit 131 detects the inter-group error ΔgPr and shifts the signal phase received by an antenna(s) belonging to an antenna group by the inter-group error ΔgPr. For example, the operation unit 131 controls the FIRs connected to the RX circuits connected to ANT#2, #4, #6, and #8 so that the phases of the signals outputted by the RX circuits are shifted by ΔgPr.

The amplitude error correction is performed in the same way. When TX correction is performed, antenna groups of transmitting antennas are formed. Thus, by reading the “transmitting antenna” in the above description as “receiving antenna,” TX correction is performed in the same way.

(RX Correction)

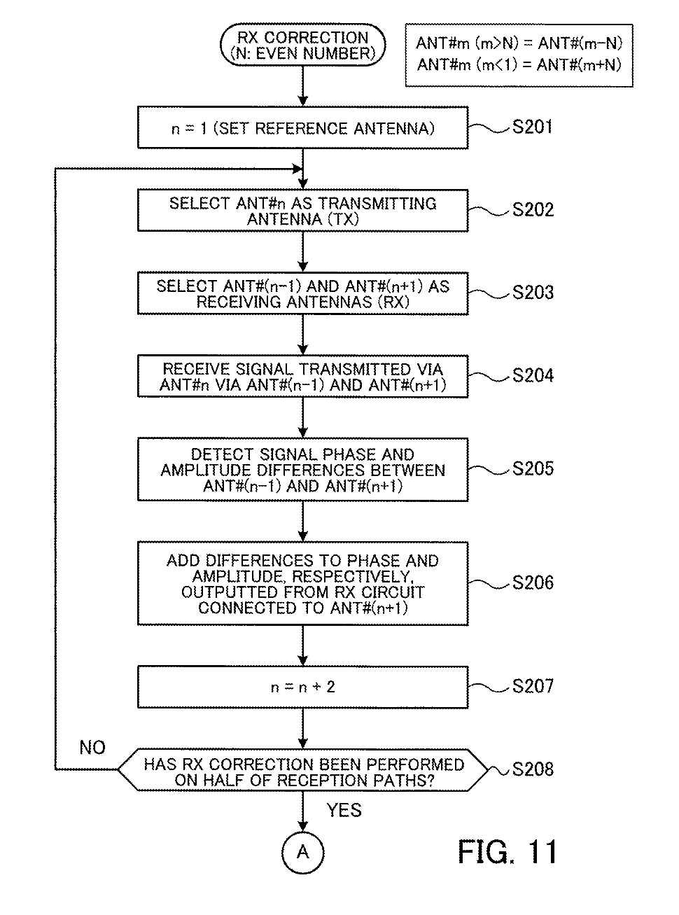

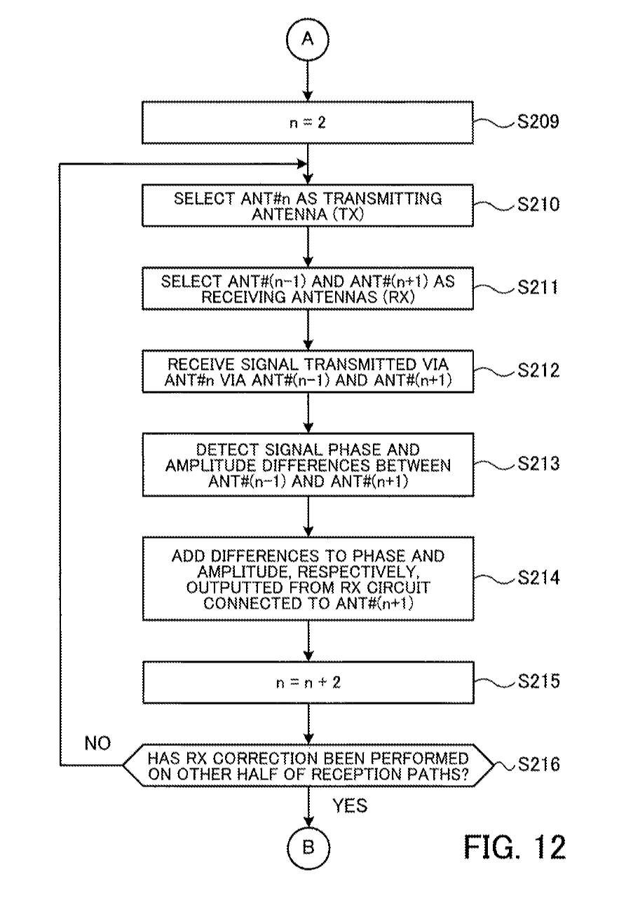

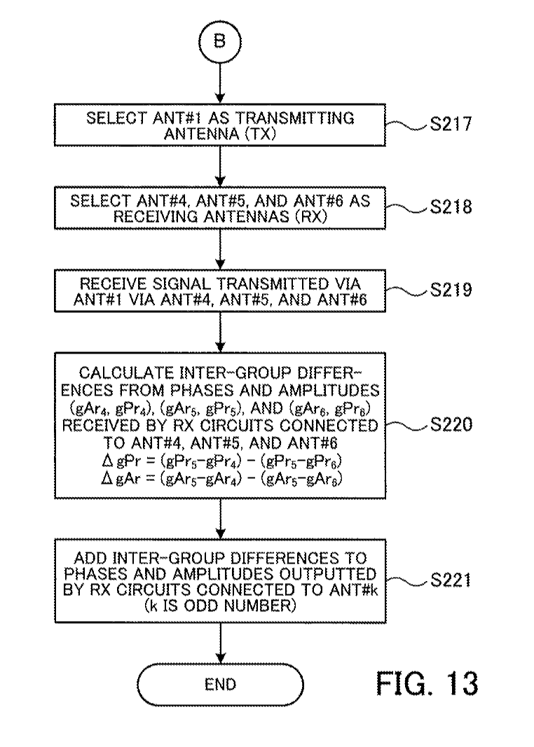

Next, RX correction processing performed by the radio apparatus 100 when the number of antennas is an even number will be described in more detail with reference to FIGS. 11 to 13.

FIGS. 11 to 13 are flowcharts illustrating RX correction processing performed by the radio apparatus according to the second embodiment (when the number of antennas is an even number);

In the following example, for convenience of the description, the radio apparatus 100 includes N antennas (N is an even number) and the n-th antenna will be referred to as ANT#n. In addition, ANT#m(m>N) and ANT#(m−N) represent the same antenna. In addition, ANT#m(m<1) and ANT#(m+N) represent the same antenna. In addition, ANT#1, ANT#2, . . . , ANT#N are arranged at regular intervals in the order of their indexes #1, #2, . . . , #N.

(S201) The operation unit 131 selects ANT#1 as a reference antenna and sets the index n to 1.

(S202) The operation unit 131 selects ANT#n as the transmitting antenna (TX).

(S203) The operation unit 131 selects ANT#(n−1) and ANT#(n+1) as the receiving antennas (RX). Namely, the operation unit 131 selects the two antennas neighboring ANT#n as the receiving antennas.

(S204) The operation unit 131 causes the RF circuit connected to the transmitting antenna to transmit a signal via ANT#n and causes the RF circuits connected to the receiving antennas to receive the signal transmitted via ANT#n via ANT#(n−1) and ANT#(n+1).

(S205) The phase and amplitude detector 133 detects the amplitudes and phases of the signals received by ANT#(n−1) and ANT#(n+1) and stores information about the detected amplitudes and phases in the RAM 132. The operation unit 131 refers to the information stored in the RAM 132 and detects the difference ΔrP₍ₙ₋₁₎₍ₙ₊₁₎ between the phases of the signals received by ANT#(n−1) and ANT#(n+1). The operation unit 131 detects the difference ΔrA₍ₙ₋₁₎₍ₙ₊₁₎ between the amplitudes in the same way.

The phase shift amount caused in the transmission path of ANT#k (k=1, 2, . . . , N) will be denoted by tPₖ, and the phase shift amount caused in the reception path of ANT#k will be denoted by rPₖ. In addition, the amplitude shift amount caused in the transmission path of ANT#k will be denoted by tAₖ, and the amplitude shift amount caused in the reception path of ANT#k will be denoted by rAₖ. When ANT#(k−1) and ANT#(k+1) are selected as the receiving antennas, the phase difference ΔrP₍ₖ₋₁₎₍ₖ₊₁₎ is represented by (rP₍ₖ₋₁₎−rP₍ₖ₊₁₎, and the amplitude difference ΔrA₍ₖ₋₁₎₍ₖ₊₁₎ is represented by (rA₍ₖ₋₁₎−rA₍ₖ₊₁₎).

(S206) The operation unit 131 sets a phase shift amount in an FIR connected to an RX circuit connected to ANT#(n+1) so that the difference ΔrP₍ₙ₋₁₎₍ₙ₊₁₎ is added to the signal phase outputted from the RX circuit. In addition, the operation unit 131 sets an amplitude shift amount in the FIR connected to the RX circuit connected to ANT#(n+1) so that the difference ΔrA₍ₙ₋₁₎₍ₙ₊₁₎ is added to the signal amplitude outputted from the RX circuit.

(S207) The operation unit 131 increments the index n by 2.

(S208) The operation unit 131 determines whether RX correction has been performed on half of the reception paths (correction on the signal amplitudes and phases outputted from half of the RX circuits).

Since the index n is set to 1 in S201, an antenna having an odd-numbered index is selected as the transmitting antenna in S202. Thus, from S202 to S207, RX correction is performed on the reception paths of the antennas belonging to the even-numbered antenna group.

For example, when all pairs of selectable receiving antennas have been selected (n>N), the operation unit 131 determines that the RX correction has been performed on half of the reception paths. When the RX correction has been performed on half of the reception paths, the processing proceeds to S209. Otherwise, the processing returns to S202.

(S209) The operation unit 131 sets the index n to 2. Namely, the operation unit 131 performs RX correction on the reception path of an antenna belonging to the odd-numbered antenna group.

(S210) The operation unit 131 selects ANT#n as the transmitting antenna (TX).

(S211) The operation unit 131 selects ANT#(n−1) and ANT#(n+1) as the receiving antennas (RX). Namely, the operation unit 131 selects the two antennas neighboring ANT#n as the receiving antennas.

(S212) The operation unit 131 causes the RF circuit connected to the transmitting antenna to transmit a signal via ANT#n and causes the RF circuits connected to the receiving antennas to receive the signal transmitted via ANT#n via ANT#(n−1) and ANT#(n+1).

(S213) The phase and amplitude detector 133 detects the amplitudes and phases of the signals received by ANT#(n−1) and ANT#(n+1) and stores information about the detected amplitudes and phases in the RAM 132. The operation unit 131 refers to the information stored in the RAM 132 and detects the difference ΔrP₍ₙ₋₁₎₍ₙ₊₁₎ between the phases of the signals received by ANT#(n−1) and ANT#(n+1). The operation unit 131 detects the difference ΔrA₍ₙ₋₁₎₍ₙ₊₁₎ between the amplitudes in the same way.

(S214) The operation unit 131 sets a phase shift amount in an FIR connected to an RX circuit connected to ANT#(n+1) so that the difference ΔrP₍ₙ₋₁₎₍ₙ₊₁₎ is added to the signal phase outputted from the RX circuit. In addition, the operation unit 131 sets an amplitude shift amount in the FIR connected to the RX circuit connected to ANT#(n+1) so that the difference ΔrA₍ₙ₋₁₎₍ₙ₊₁₎ is added to the signal amplitude outputted from the RX circuit.

(S215) The operation unit 131 increments the index n by 2.

(S216) The operation unit 131 determines whether RX correction has been performed on the other half of the reception paths (correction on the signal amplitudes and phases outputted from the other half of the RX circuits).

Since the index n is set to 2 in S209, an antenna having an even-numbered index is selected as the transmitting antenna in S210. Thus, from S210 to S215, RX correction is performed on the reception paths of the antennas belonging to the odd-numbered antenna group.

For example, when all pairs of selectable receiving antennas have been selected (n>N), the operation unit 131 determines that the RX correction has been performed on the other half of the reception paths. When the RX correction has been performed on the other half of the reception paths, the processing proceeds to S217. Otherwise, the processing returns to S210.

(S217) To perform inter-group correction, the operation unit 131 selects ANT#1 as the transmitting antenna (TX). ANT#1 belongs to the odd-numbered antenna group.

(S218) The operation unit 131 selects ANT#4, ANT#5, and ANT#6 as the receiving antennas (RX). ANT#4 and ANT#6 are a pair of antennas that belong to the even-numbered antenna group, which is different from the odd-numbered antenna group to which ANT#1 belongs, and that are equally distanced from ANT#1. ANT#5 is an antenna that belongs to the odd-numbered antenna group to which ANT#1 also belongs and is equally distanced from ANT#4 and #6.

(S219) The operation unit 131 controls the relevant RF circuits so that a signal transmitted by ANT#1 is received by ANT#4, ANT#5, and ANT#6. The amplitude gAr₄ and phase gPr₄ received by the RX circuit connected to ANT#4, the amplitude gAr₅ and phase gPrₐ received by the RX circuit connected to ANT#5, and the amplitude gAr₆ and phase gPr₆ received by the RX circuit connected to ANT#6 are detected by the phase and amplitude detector 133. Information about the detected amplitudes and phases is stored in the RAM 132.

(S220) The operation unit 131 refers to the RAM 132 and acquires the information about the amplitudes and phases (gAr₄, gPr₄), (gAr₅, gPr₅), and (gAr₆, gPr₆). Next, the operation unit 131 calculates an inter-group phase error ΔgPr and an inter-group amplitude error ΔgAr on the basis of the following expressions (1) and (2).

ΔgPr=(gPr₅−gPr₄)−(gPr₅−gPr₆) (1)

ΔgAr=(gAr₅−gAr₄)−(gAr₅−gAr₆) (2)

(S221) The operation unit 131 controls relevant FIRs so that ΔgPr (inter-group difference) is added to the signal phases outputted by the RX circuits connected to all ANT#k (k is an odd number) belonging to the odd-numbered antenna group. In addition, the operation unit 131 controls relevant FIRs so that ΔgAr (inter-group difference) is added to the signal amplitudes outputted by the RX circuits connected to all ANT#k (k is an odd number) belonging to the odd-numbered antenna group. Namely, the operation unit 131 corrects the inter-group errors by using ΔgPr and ΔgAr.

After S221, the operation unit 131 ends the processing illustrated in FIGS. 11 to 13. Inter-group errors are corrected by applying the above method. Even when the number of antennas is an even number, RX correction is achieved on all the reception paths.

(TX Correction)

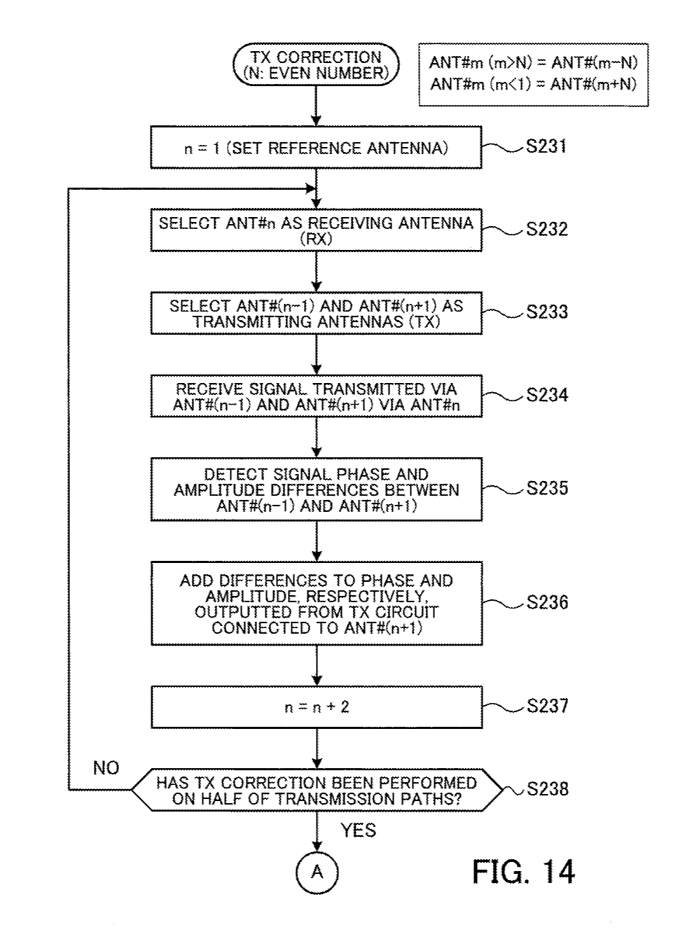

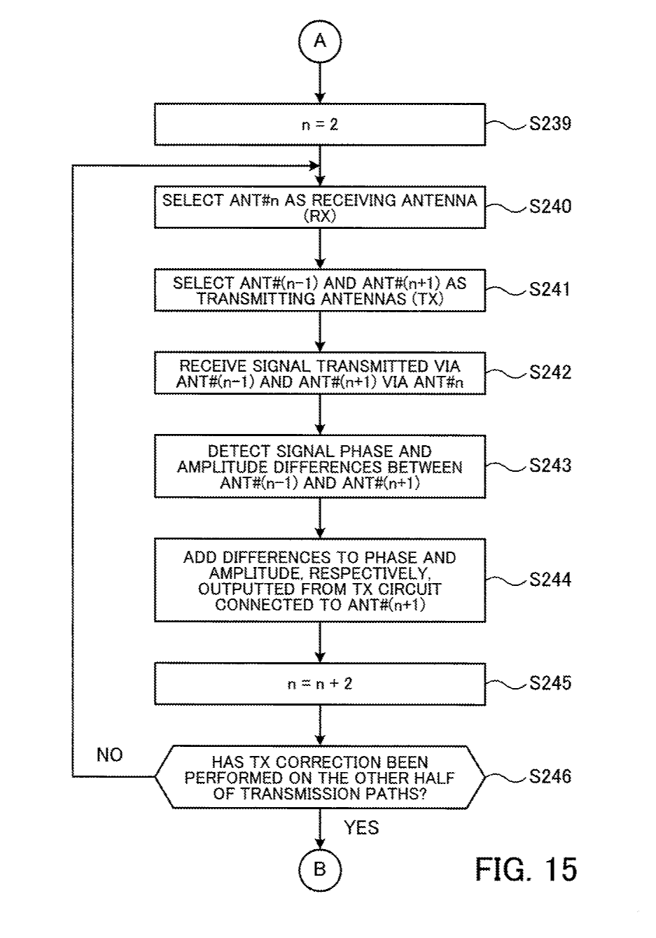

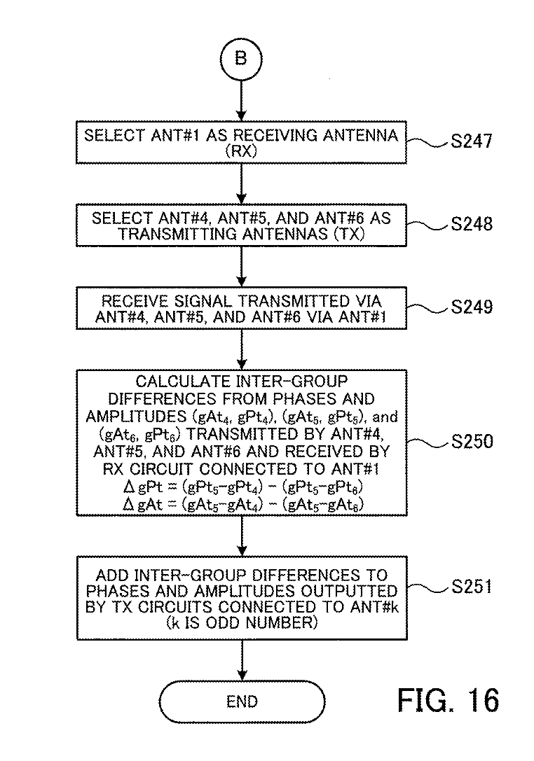

Next, TX correction processing performed by the radio apparatus 100 when the number of antennas is an even number will be described in detail with reference to FIGS. 14 to 16.

FIGS. 14 to 16 are flowcharts illustrating TX correction processing performed by the radio apparatus according to the second embodiment (when the number of antennas is an even number).

(S231) The operation unit 131 selects ANT#1 as a reference antenna and sets the index n to 1.

(S232) The operation unit 131 selects ANT#n as the receiving antenna (RX).

(S233) The operation unit 131 selects ANT#(n−1) and ANT#(n+1) as the transmitting antennas (TX). Namely, the operation unit 131 selects the two antennas neighboring ANT#n as the transmitting antennas.

(S234) The operation unit 131 causes the RF circuits connected to the respective transmitting antennas to transmit a signal via ANT#(n−1) and ANT#(n+1) and causes the RF circuit connected to the receiving antenna to receive the signals transmitted via ANT#(n−1) and ANT#(n+1) via ANT#n.

(S235) The phase and amplitude detector 133 detects the amplitudes and phases of the signals transmitted by ANT#(n−1) and ANT#(n+1) and stores information about the detected amplitudes and phases in the RAM 132. The operation unit 131 refers to the information stored in the RAM 132 and detects the difference ΔtP₍ₙ₋₁₎₍ₙ₊₁₎ between the phases of the signals transmitted by ANT#(n−1) and ANT#(n+1). The operation unit 131 detects the difference ΔtA₍ₙ₋₁₎₍ₙ₊₁₎ between the amplitudes in the same way.

The phase shift amount caused in the transmission path of ANT#k (k=1, 2, . . . , N) will be denoted by tPₖ, and the phase shift amount caused in the reception path of ANT#k will be denoted by rPₖ. In addition, the amplitude shift amount caused in the transmission path of ANT#k will be denoted by tAₖ, and the amplitude shift amount caused in the reception path of ANT#k will be denoted by rAₖ. When ANT#(k−1) and ANT#(k+1) are selected as the transmitting antennas, the phase difference ΔtP₍ₖ₋₁₎₍ₖ₊₁₎ is represented by (tP₍ₖ₋₁₎−tP₍ₖ₊₁₎), and the amplitude difference ΔtA₍ₖ₋₁₎₍ₖ₊₁₎ is represented by (tA₍ₖ₋₁₎−tA₍ₖ₊₁₎).

(S236) The operation unit 131 sets a phase shift amount in an FIR connected to a TX circuit connected to ANT#(n+1) so that the difference ΔtP₍ₙ₋₁₎₍ₙ₊₁₎ is added to the signal phase outputted from the TX circuit. In addition, the operation unit 131 sets an amplitude shift amount in the FIR connected to the TX circuit connected to ANT#(n+1) so that the difference ΔtA₍ₙ₋₁₎₍ₙ₊₁₎ is added to the signal amplitude outputted from the TX circuit.

(S237) The operation unit 131 increments the index n by 2.

(S238) The operation unit 131 determines whether TX correction has been performed on half of the transmission paths (correction on the signal amplitudes and phases outputted from half of the TX circuits).

Since the index n is set to 1 in S231, an antenna having an odd-numbered index is selected as the receiving antenna in S232. Thus, from S232 to S237, TX correction is performed on the transmission paths of the antennas belonging to the even-numbered antenna group.

For example, when all pairs of selectable transmitting antennas have been selected (n>N), the operation unit 131 determines that the TX correction has been performed on half of the transmission paths. When the TX correction has been performed on half of the transmission paths, the processing proceeds to S239. Otherwise, the processing returns to S232.

(S239) The operation unit 131 sets the index n to 2. Namely, the operation unit 131 performs TX correction on the transmission path of an antenna belonging to the odd-numbered antenna group.

(S240) The operation unit 131 selects ANT#n as the receiving antenna (RX).

(S241) The operation unit 131 selects ANT#(n−1) and ANT#(n+1) as the transmitting antennas (TX). Namely, the operation unit 131 selects the two antennas neighboring ANT#n as the transmitting antennas.

(S242) The operation unit 131 causes the RF circuits connected to ANT#(n−1) and ANT#(n+1) to transmit a signal and causes the RF circuit connected to ANT#n to receive the signal transmitted via ANT#(n−1) and ANT#(n+1) via ANT#n.

(S243) The phase and amplitude detector 133 detects the amplitudes and phases of the signals transmitted by ANT#(n−1) and ANT#(n+1) and stores information about the detected amplitudes and phases in the RAM 132. The operation unit 131 refers to the information stored in the RAM 132 and detects the difference ΔtP₍ₙ₋₁₎₍ₙ₊₁₎ between the phases of the signals transmitted by ANT#(n−1) and ANT#(n+1). The operation unit 131 detects the difference ΔtA₍ₙ₋₁₎₍ₙ₊₁₎ between the amplitudes in the same way.

(S244) The operation unit 131 sets a phase shift amount in an FIR connected to a TX circuit connected to ANT#(n+1) so that the difference ΔtP₍ₙ₋₁₎₍ₙ₊₁₎ is added to the signal phase outputted from the TX circuit. In addition, the operation unit 131 sets an amplitude shift amount in the FIR connected to the TX circuit connected to ANT#(n+1) so that the difference ΔtA₍ₙ₋₁₎₍ₙ₊₁₎ is added to the signal amplitude outputted from the TX circuit.

(S245) The operation unit 131 increments the index n by 2.

(S246) The operation unit 131 determines whether TX correction has been performed on half of the transmission paths (correction on the signal amplitudes and phases outputted from the other half of the TX circuits).

Since the index n is set to 2 in S239, an antenna having an even-numbered index is selected as the receiving antenna in S240. Thus, from S240 to S245, TX correction is performed on the transmission paths of the antennas belonging to the odd-numbered antenna group.

For example, when all pairs of selectable transmitting antennas have been selected (n>N), the operation unit 131 determines that the TX correction has been performed on the other half of the transmission paths. When the TX correction has been performed on the other half of the transmission paths, the processing proceeds to S247. Otherwise, the processing returns to S240.

(S247) To perform inter-group correction, the operation unit 131 selects ANT#1 as the receiving antenna (RX). ANT#1 belongs to the odd-numbered antenna group.

(S248) The operation unit 131 selects ANT#4, ANT#5, and ANT#6 as the transmitting antennas (TX). ANT#4 and ANT#6 are a pair of antennas that belong to the even-numbered antenna group, which is different from the odd-numbered antenna group to which ANT#1 belongs, and that are equally distanced from ANT#1. ANT#5 is an antenna that belongs to the odd-numbered antenna group to which ANT#1 also belongs and is equally distanced from ANT#4 and #6.

(S249) The operation unit 131 controls the relevant RF circuits so that a signal transmitted by ANT#4, ANT#5, and ANT#6 is received by ANT#1. The amplitude gAt₄ and phase gPt₄ transmitted by ANT#4 and received by the RX circuit connected to ANT#1, the amplitude gAtₐ and phase gPt₅ transmitted by ANT#5 and received by the RX circuit connected to ANT#1, and the amplitude gAt₆ and phase gPt₆ transmitted by ANT#6 and received by the RX circuit connected to ANT#1 are detected by the phase and amplitude detector 133. Information about the detected amplitudes and phases is stored in the RAM 132.

(S250) The operation unit 131 refers to the RAM 132 and acquires the information about the amplitudes and phases (gAt₄, gPt₄), (gAt₅, gPt₅), and (gAt₆, gPt₆). Next, the operation unit 131 calculates an inter-group phase error ΔgPt and an inter-group amplitude error ΔgAt on the basis of the following expressions (3) and (4).

ΔgPt=(gPt₅−gPt₄)−(gPt₅−gPt₆) (3)

ΔgAt=(gAt₅−gAt₄)−(gAt₅−gAt₆) (4)

(S251) The operation unit 131 controls relevant FIRs so that ΔgPt (inter-group difference) is added to the signal phases outputted by the TX circuits connected to all ANT#k (k is an odd number) belonging to the odd-numbered antenna group. In addition, the operation unit 131 controls relevant FIRs so that ΔgAt (inter-group difference) is added to the signal amplitudes outputted by the TX circuits connected to all ANT#k (k is an odd number) belonging to the odd-numbered antenna group. Namely, the operation unit 131 corrects the inter-group errors by using ΔgPt and ΔgAt.

After S251, the operation unit 131 ends the processing illustrated in FIGS. 14 to 16. Inter-group errors are corrected by applying the above method. Even when the number of antennas is an odd number, TX correction is achieved on all the transmission paths.

(Improvement of Beam Characteristics)

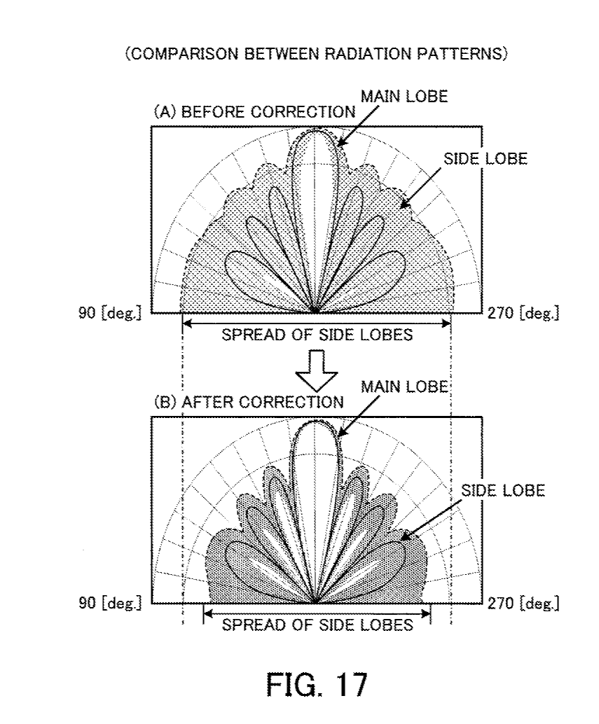

When the above technique according to the second embodiment is applied to correct errors in transmission and reception paths, the directivity of a beam is improved as illustrated in FIG. 17. FIG. 17 illustrates comparison between radiation patterns obtained before and after amplitude and phase errors in RF circuits are corrected.

(A) of FIG. 17 illustrates a radiation pattern obtained before amplitude and phase errors in RF circuits are corrected. The hatched area in (A) of FIG. 17 represents beam spread. As illustrated in (A) of FIG. 17, when errors as described above are caused, the side lobes spread widely. As a result, more interference with neighboring cells is caused. (B) of FIG. 17 illustrates a radiation pattern obtained after the amplitude and phase errors in the RF circuits are corrected. When the radiation patterns in (A) and (B) of FIG. 17 are compared with each other, it is seen that the spread of the side lobes has been reduced in (B) of FIG. 17. Namely, it is seen that the above technique according to the second embodiment has an advantageous effect of reducing the inter-cell interference.

[2-4. Correction Timing and Power Control]

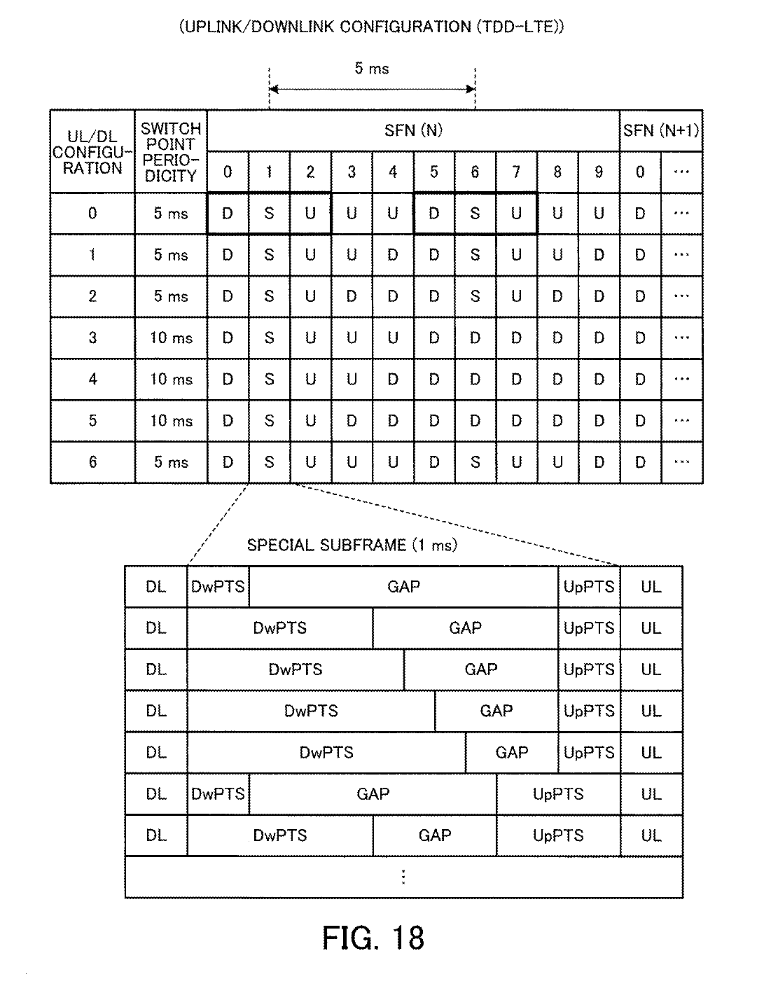

The above technique according to the second embodiment is applicable to various radio communication systems. For example, the technique is applicable to a radio communication system based on a TDD method. For example, in a TDD-LTE (Long Term Evolution) method, uplink and downlink communication timings are defined as illustrated in FIG. 18. FIG. 18 illustrates correction timing control according to the second embodiment.

As illustrated in FIG. 18, one single frequency network (SFN) is divided into a plurality of subframes (subframes 0 to 9) including downlink subframes (D) in which downlink communication is allowed and uplink subframes (U) in which uplink communication is allowed. In addition, a period (switch point periodicity) is set, and a downlink subframe (D) and an uplink subframe (U) are switched on the basis of this period.

In addition, when a downlink subframe (D) and an uplink frame (U) are switched, a special subframe (S) is inserted therebetween. An individual special subframe (S) is divided into three periods (a downlink pilot time slot (DwPTS), GAP, an uplink PTS (UpPTS)). GAP is a period in which neither transmission nor reception is performed. DL and UL are for downlink and uplink communications, respectively.

In a TDD method, the same frequency is used for transmission and reception. Since transmission and reception units corresponding to all antennas are synchronized with each other, one unit does not receive a signal while another unit is transmitting a signal. Thus, when the correction method according to the second embodiment in which a plurality of antennas included in a single antenna array are allocated to transmission and reception is applied, it is suitable to detect errors by using the above GAP periods.

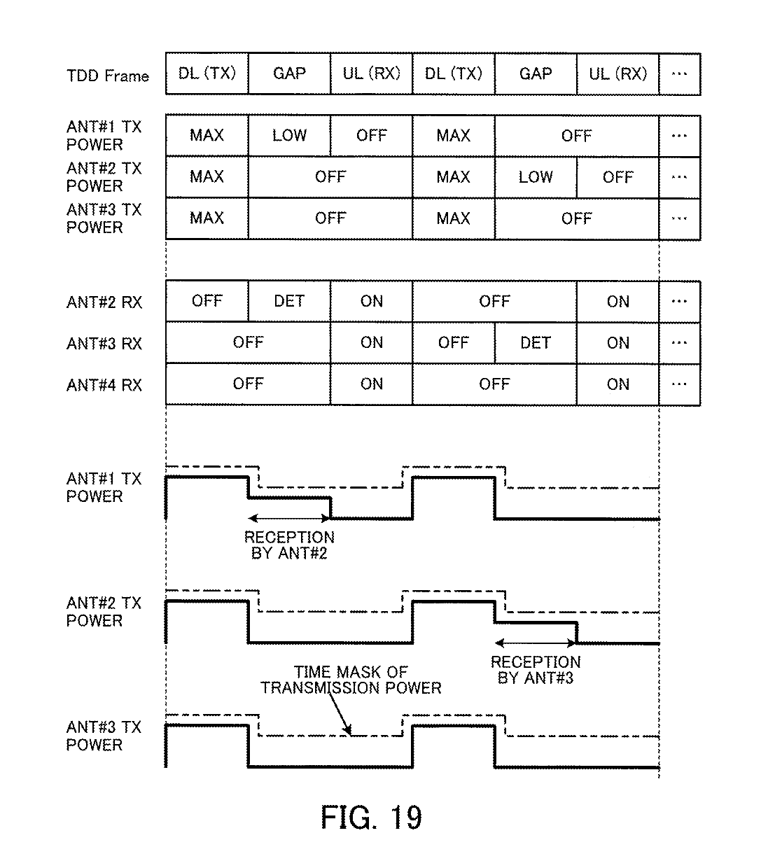

For example, when ANT#1, . . . , ANT#4 are used, as illustrated in FIG. 19, when to transmit and receive signals used for error detection is controlled so that ANT#1, ANT#2, etc. sequentially transmit signals and ANT#2, ANT#3, etc. sequentially receive the signals by using the GAP periods. FIG. 19 illustrates power control performed when the amplitude and phase correction according to the second embodiment is performed.

In FIG. 19, MAX, OFF, and LOW represent when an antenna is transmitting maximum, minimum, and low power, respectively. In addition, ON represents when an antenna is receiving a signal, and DET represents when an antenna is detecting a signal used for error correction. In addition, an individual dashed-dotted line in FIG. 19 represents a time mask of transmission power. An individual time mask defines change between an OFF state and an ON state (MAX) and the maximum activation time of a transmission signal. Since change to an OFF state is needed in a GAP period, the power used to transmit a signal for error correction is set to be lower than the time mask value in the GAP period, so as not to violate the radio law.

The second embodiment has thus been described.

Amplitude and phase errors caused in a reception path of an individual antenna are easily detected.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A radio apparatus comprising:
a radio transceiver configured to transmit and receive a signal via a plurality of antennas; and
a processor configured to control the radio transceiver so that a signal transmitted by a first antenna among the plurality of antennas is received by second and third antennas neighboring the first antenna and detect at least one of difference between amplitudes of signals received by the respective second and third antennas and difference between phases of the signals received by the respective second and third antennas.

2. The radio apparatus according to claim 1,
wherein distance between the first and second antennas and distance between the first and third antennas are the same, and
wherein the processor corrects at least one of an error between the amplitudes of the signals received by the respective second and third antennas on the basis of the difference between the amplitudes and an error between the phases of the signals received by the respective second and third antennas on the basis of the difference between the phases.

3. The radio apparatus according to claim 1,
wherein the radio transceiver transmits and receives a signal by using a time division duplex transmission method in which, when uplink and downlink frames are switched, a predetermined frame in which neither transmission nor reception is performed is inserted between the uplink and downlink frames, and
wherein the processor causes the radio transceiver to transmit and receive a signal for detecting at least one of the differences by using the predetermined frame.

4. The radio apparatus according to claim 2,
wherein a number of antennas is an even number of 4 or more, and
wherein the processor corrects at least one of the errors among odd-numbered antennas of the plurality of antennas, corrects at least one of the errors among even-numbered antennas of the plurality of antennas, and corrects at least one error caused between signals received by the odd-numbered antennas and signals received by the even-numbered antennas.

5. The radio apparatus according to claim 1,
wherein the processor controls the radio transceiver so that signals transmitted by fifth and sixth antennas neighboring a fourth antenna among the plurality of antennas are received by the fourth antenna, and
wherein the processor detects at least one of difference between amplitudes of the signals transmitted by the respective fifth and sixth antennas and difference between phases of the signals transmitted by the respective fifth and sixth antennas.

6. A detection method, comprising:
causing, by a processor, a radio apparatus including a radio transceiver that transmits and receives a signal via a plurality of antennas and the processor, to control the radio transceiver so that a signal transmitted by a first antenna among the plurality of antennas is received by second and third antennas neighboring the first antenna; and
causing, by the processor, the radio apparatus to detect at least one of difference between amplitudes of signals received by the respective second and third antennas and difference between phases of the signals received by the respective second and third antennas.
